(19) United States
(12) Patent Application Publication
(10) Pub. No.: US 2005/0275875 A1
(43) Pub. Date: Dec. 15, 2005

(54) System and method for printer-side print queue priority self-monitoring

(75) Inventor: Robert Cory Jennings JR., Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/855,733

(22) Filed: May 27, 2004

(51) Int. Cl. G06F 15/00

(52) U.S. Cl. 358/1.15

(57) ABSTRACT

A system and method for printer-side print queue priority self-monitoring are provided. With the system and method, a priority monitoring mechanism is provided that classifies print jobs into preemptable print jobs and print jobs that may cause preemption. In operation, if a preemptable print job is being processed and a print job that may cause preemption is waiting in a print queue, the preemptable print job may be automatically preempted and processing of the other print job may be automatically initiated. The output of the other print job is automatically redirected to a different output device so that it is separated from the output of the preemptable print job. Preemption is permitted when the other print job has waited for a predetermined period of time in the print queue and the preemptable print job has not been preempted for more that a predetermined period of time by other print jobs.

### BACKGROUND OF THE INVENTION

1. Technical Field

The present invention is generally directed to an improved computing system. More specifically, the present invention is directed to a computing system and method in which a printer-side print queue priority self-monitoring mechanism is provided.

2. Description of Related Art

In environments where print resources are shared between users and jobs are printed on a first come, first served basis, a large print job can hurt productivity while users wait for smaller jobs submitted later to complete. Administrators can manually hold jobs or manually adjust the print order, but this requires intervention from some authority to make such changes. In a situation where a user prints to a busy printer, they may wait a fair amount of time before they can pick up the printer output. This results in a loss of productivity or the user may print to another printer resource and discard the original print job when it arrives. This results in a waste of printer resources.

Therefore, it would be beneficial to have a system and method in which printers may perform self-monitoring such that large print jobs are preempted in favor of smaller print jobs.

### SUMMARY OF THE INVENTION

The present invention provides a system and method for printer-side print queue priority self-monitoring. With the system and method of the present invention, a printer is provided with a priority monitoring mechanism that ranks an incoming print job into one of a plurality of categories, e.g., large, medium or small. This ranking may be performed based on, for example, the number of pages in the print job relative to pre-established thresholds defining the various categories. Each incoming print job is tagged with a number of pages and the time of arrival of the print job. Based on the tagged number of pages, the print job is categorized into one of the various categories.

The printer having the priority monitoring mechanism of the present invention may preempt print jobs that are categorized as “large” print jobs. While printing any “large” print job, the printer priority monitoring mechanism periodically checks the state of the printer queue. If a smaller job is waiting to be printed, a determination is made as to whether the large print job should be preempted so that the smaller print job may be printed. These smaller print jobs would be output by the printer to a separate output tray from that in which the large print job is being output in order to avoid any intermingling of the print jobs due to the preemption.

In order to implement the priority monitoring mechanism of the present invention, a number of values are calculated or generated upon which the priority monitoring mechanism of the printer operates to determine when to preempt large print jobs and when to discontinue the preemption. These values include thresholds that define the upper bounds of the various categories of print jobs, a queue check interval that identifies how often the queue is checked for smaller print jobs, a maximum interruption value that identifies the amount of time that any single period of preemption can last, a maximum preemption time that identifies the maximum cumulative amount of time that a print job can be preempted after which it is no longer subject to preemption, and a minimum wait time that identifies an amount of time a small job must age in the print queue before it can cause a large print job to be preempted.

The method of determining when to preempt a large print job and when to print a small print job is based on a function of the time that the large print job has already been preempted, the number of pages remaining to be printed in the large print job, and an age of the waiting smaller print job. While the number of pages remaining in the job is great enough for the job to be classified as “large,” an amount of time that the job has already been preempted has not exceeded the maximum preemption time, it may be preempted. During a regular check of the printer queue, such as at the queue check interval, and while there are small jobs present on the printer queue, preemption can occur. The large print job may be preempted by a smaller print job if the age of the oldest small job is high enough to exceed a minimum wait period. By forcing the small print job to age for a period of time, the number of interruptions of print jobs can be reduced without affecting small jobs significantly. When a small print job finishes printing, if there are other small print jobs on the print queue, the next one may be printed if the period of time that the large job has been halted overall for the life of the large print job is within the maximum preemption time and the current period of preemption is within a maximum interruption value. Once a large print job has been preempted by a smaller print job, any small print jobs that are pending in the print queue while the preemption is performed may preempt the large print job without having to meet the minimum waiting time criteria.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating an exemplary distributed data processing system in which aspects of the present invention may be implemented;

FIG. 2 is an exemplary diagram of a server computing device in which aspects of the present invention may be implemented;

FIG. 3 is an exemplary diagram of a client computing device in which aspects of the present invention may be implemented;

FIG. 4 is an exemplary diagram illustrating the interaction of the primary operational components of the present invention;

FIG. 5 is a block diagram of one exemplary embodiment of a printer print queue priority self-monitoring mechanism in accordance with the present invention; and

FIG. 6 is a flowchart outlining an exemplary operation of the present invention when performing print queue priority self-monitoring.

### DETAILED DESCRIPTION OF THE PREFERRED EMBODIMENT

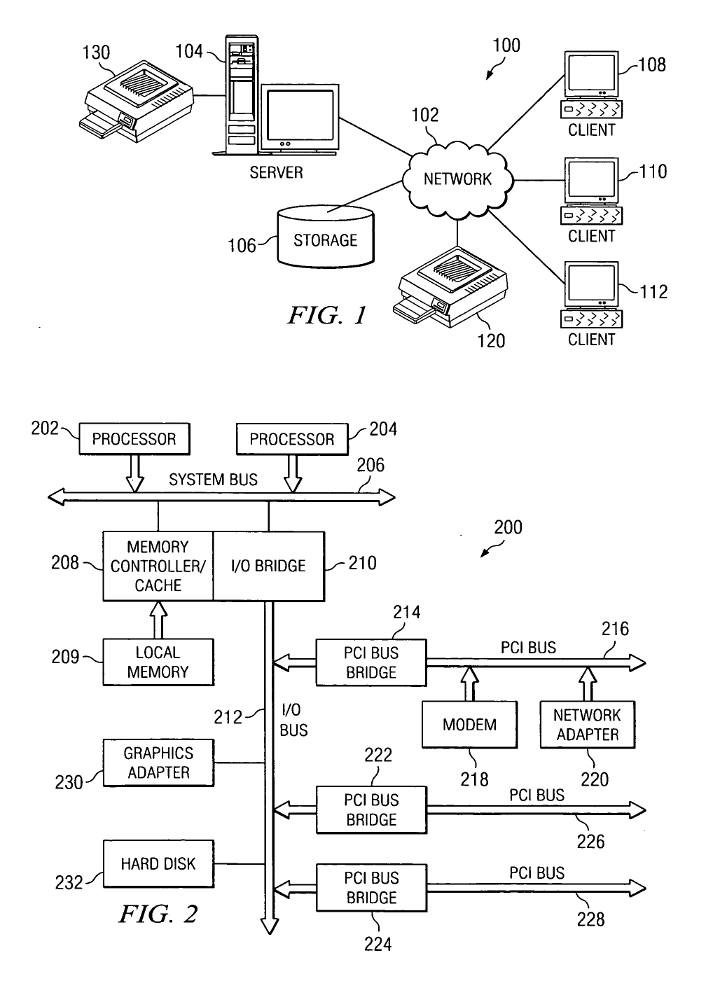

The present invention provides a mechanism for self-monitoring of a printer print queue so that large print jobs may be pre-empted in favor of smaller print jobs under certain circumstances. The present invention is best suited for use with printers that receive a large number of jobs of various sizes from a plurality of different users. Thus, the present invention is especially well suited for printers that operate in a distributed data processing system. However, the present invention may also be implemented in an environment in which there is a single computing device coupled to the printer. Thus, the following FIGS. 1-3 are intended to provide a context of the possible environment in which one embodiment of the present invention may be implemented. FIGS. 1-3 are only exemplary and are not intended to state or imply any limitation as to the particular computing environments in which the mechanisms of the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

A network printers 120 and 130 may be provided in the distributed data processing system 100 for printing documents, images, and the like, associated with print jobs submitted by the clients 108, 110 and 112. The network printer 120 may be coupled directly to the network 102 if the network printer 120 has a built-in print server mechanism that permits the printer to manage print jobs that are submitted to it. Alternatively, the network printer 130 may be coupled to a server, such as server 104, which may act as a print server for monitoring and managing the print jobs that are submitted to the network printer 102. If the network printer 120 is coupled directly to the network 102, the mechanisms of the present invention as discussed hereafter may be implemented in the network printer 120 itself as part of the print job management mechanism. If the network printer 130 is coupled to the network 102 via a server, e.g., server 104, the mechanisms of the present invention may be implemented in either the server 104 or in the network printer 130, if the network printer 130 has a print job management mechanism similar to that of network printer 120.

The network printers 120 and 130 preferably include multiple output trays or mechanisms for physically separating the output of print jobs submitted to them. As will be discussed hereafter, one of the primary features of the present invention is the ability to preempt a large print job in order to print a smaller print job. Therefore, the network printers 120 and 130 should have mechanisms for separating the output of the preempted print job from the output of the smaller print job so that intermingling of the output from these print jobs is avoided. One mechanism for separating these outputs is to provide two or more output trays with the smaller print jobs that preempt a large print job being directed to a different output tray than the one that the large print job is currently being output to. Other mechanisms, such as physical separators, may be utilized to ensure that the output of the preempted print jobs and the smaller print jobs are kept separate, without departing from the spirit and scope of the present invention.

In the depicted example, network data processing system 100 may be a local area network (LAN), wide area network (WAN), intranet, or the like. In addition, the network data processing system 100 may be the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

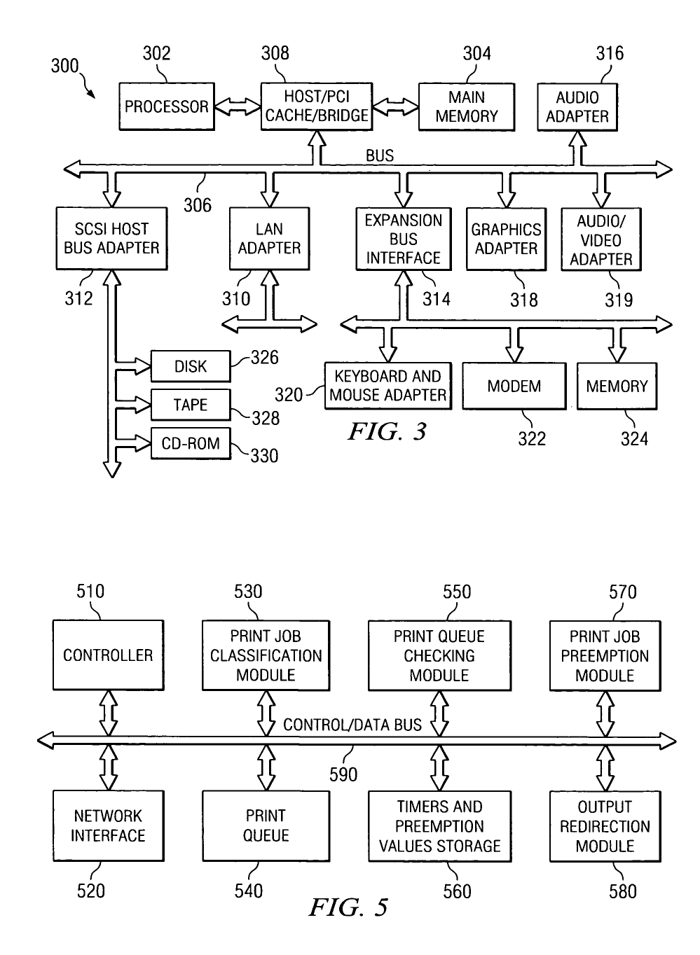

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As discussed above, the present invention is directed to a printer print queue priority self-monitoring mechanism. With the present invention, mechanisms are provided for determining when to permit preempting of print jobs so that other print jobs may be executed. In particular, the present invention permits print jobs that are categorized as large print jobs to be preempted so that smaller print jobs may be completed. While a large print job is being printed, the print queue for the printer is periodically checked to determine if there are any smaller print jobs waiting to be processed. If there are smaller print jobs waiting, a determination is made as to whether the longest waiting smaller print job has waited a minimum wait period. If so, a determination is made as to whether a large print job is to be preempted so that the longest waiting smaller print job may be processed.

The determination as to whether the large print job should be preempted is based on a determination as to whether the number of pages yet to be printed in the print job are such that the large print job may still be classified as a large print job. If not, i.e. the print job can no longer be categorized as a large print job, then preemption is not permitted. If the print job may still be categorized as a large print job, a determination is made as to whether the large print job has already been preempted by other print jobs by an amount of time greater than a maximum preemption time.

If the large print job has already been preempted by an amount of time greater than a maximum preemption time, then further preemption is not permitted. If the large print job has not been preempted for more than the maximum preemption time, the large print job is preempted. As a result, the printing of the large print job is suspended and the printing of the smaller print job is initiated. The output of the smaller print job is directed to a separate output tray than the large print job in order to avoid intermingling of print jobs.

Following completion of the smaller print job, a determination is made as to whether the print queue includes any other smaller print jobs that may preempt the large print job. If so, a determination is made as to whether the amount of time that the large print job has currently been preempted is greater than a predetermined threshold. If not, then the smaller print job waiting in the print queue may be immediately processed without the smaller print job having to wait the predetermined required wait period. If, however, the current preemption time is greater than the threshold amount of time that a large print job may be interrupted, then further preemption of the large print job is not permitted.

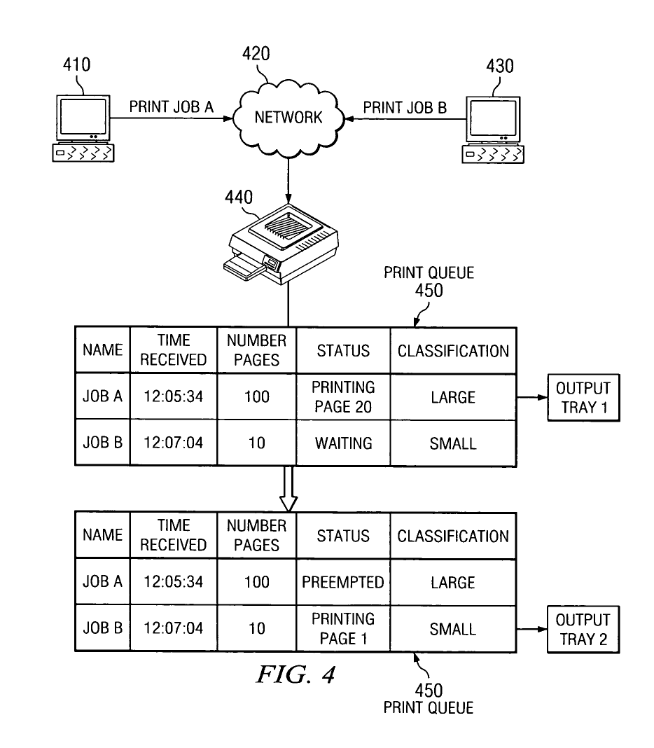

FIG. 4 is an exemplary diagram illustrating the interaction of the primary operational components of the present invention. The embodiment illustrated in FIG. 4 assumes that the network printer 440 is directly connected to the network 420, however, as noted above, the network printer 440 may be coupled to the network 420 via a server computing device in which aspects of the present invention may be implemented.

Client devices 410 and 430 may submit print jobs to network printer 440 via the network 420. The network printer 440 includes a print job management mechanism in accordance with the present invention, which determines when to preempt large print jobs in favor of smaller print jobs and when not to perform such preemption. This mechanism may be enabled or disabled by a network administrator or other user, such as by setting a parameter associated with the network printer 440, so that the operation of the present invention may be either turned on or off.

In the depicted example, assume that client device 410 submits a first print job “Print Job A” to the network printer 440 at a first time 12:05:34 and client device 430 submits a second print job “Print Job B” to the network printer 440 at a second time 12:07:04. When the print jobs are received by the network printer 440, the print jobs are classified into a print job classification that is descriptive of whether the print job may be preempted or not. For example, upper and/or lower limit sizes for various classifications of print jobs may be pre-established and used to compare to attributes of the received print jobs in order to perform this classification.

Thus, for example, assume that three classifications of print jobs are established in the print job management-mechanism of network printer 440: Large print jobs, medium print jobs, and small print jobs. Upper limits and/or lower limits to the size of the print jobs may be established that define these classifications. For example, large print jobs may be defined as any print job of 50 pages or more. Medium size print jobs may be defined as any print job of 21 to 49 pages in size. Small print jobs may be defined as any print job of 20 pages or less. Based on these classifications, the number of pages in an incoming print job may be used to determined whether the incoming print job is a large print job, medium print job or small print job. The print job may then be tagged based on the time it arrived at the network printer 440 and the classification of the print job.

In a preferred embodiment, only one classification of print job may be preempted while one or more other classifications may be the basis upon which print jobs are preempted. That is, for example, only large print jobs may be preempted by small print jobs. Medium size print jobs do not take part in either being preempted or being the basis for preemption of other print jobs. Thus, if a large print job is being processed by the network printer 440, e.g., being printed, this processing may be suspended in favor of a small print job that is also waiting in the print queue of the network printer 440 under certain circumstances.

To illustrate this preemption, assume that Print Job A is a print job having 100 pages to-be printed. Also assume that Print Job B is a print job having 10 pages to be printed. In known printer systems, Print Job B will have to wait until Print Job A is finished before Print Job B may be processed by the network printer 440. This is assuming that there is no user intervention, such as a system administrator manually holding Print Job A or manually adjusting the order of print jobs in the print queue. With the present invention, however, as long as certain criteria are met, Print Job A may be automatically preempted so that Print Job B may be processed prior to completion of Print Job A.

The determination as to whether Print Job A should be preempted or not is based on a number of different criteria. First, a queue check interval is established within the network printer 440 by a system administrator. This queue check interval determines the periodic time intervals at which the printer print queue is checked to determine if any large print jobs are currently being processed and any small print jobs are currently waiting. At these periodic checks of the printer print queue, if it is determined that a large print job is currently being processed by the network printer 440 and there is at least one small print job waiting to be processed by the network printer 440, operations are performed to determine whether the large print job should be preempted so that the small print job may be processed.

In order to determine whether the large print job should be preempted, a determination is first made as to whether the oldest small print job has been waiting in the print queue for a minimum wait period or longer. The minimum wait period is a parameter, similar to the classification thresholds and the queue check interval, that may be set by a system administrator or other user at the time that the network printer 440 is configured. The minimum wait period identifies a minimum time that small print jobs must wait to be processed in the print queue before they may cause the preemption of a large print job. This minimum wait period helps to reduce the number of interruptions of a large print job. This parameter, as with all of the parameters and thresholds described herein, may be fine tuned by the system administrator or user so that a desirable operation of the network printer 440 is achieved.

If the oldest small print job has waited for the required minimum wait period, then a determination is made as to whether the large print job is subject to preemption. A large print job is subject to preemption by default. However, if cumulative amount of time that the large print job has been preempted by other print jobs is equal to or greater than a predetermined threshold, then the large print job may no longer be subject to preemption. In addition, if the large print job has been preempted by a small print job and the period of time the small print job has preempted the large print job, i.e. the current preemption time, is equal to or greater than a predetermined threshold, additional preemption of the large print job may not be permitted.

Thus, when initially looking at the large print job to determine whether it should be preempted, a determination is made as to whether the cumulative preemption time for previous preemptions by small print jobs is equal to or greater than a predetermined threshold. This cumulative time is maintained in a memory location and is initialized when processing of a print job, classified as a large print job, is initiated. When this large print job is preempted, a timer is started, e.g., a timestamp may be stored for the time at which the preemption occurs, and is stopped when the preemption ceases, e.g., a second timestamp may be stored for the time at which the preemption stops. This elapsed time, e.g., the difference between the time stamps, may then be added to the cumulative preemption time value stored in the cumulative preemption time memory location.

If the cumulative preemption time is equal to or greater than the predetermined threshold, then preemption is not permitted and the large print job continues to be processed while the small print job must continue to wait in the print queue. If the cumulative preemption time is not greater than the predetermined threshold, then a determination is made as to whether the large print job has recently been preempted and, if so, whether that preemption lasted for more than a threshold amount of time. That is, if the large print job was preempted just prior to the present print job attempting to preempt the large print job, it is determined whether the time period that the previous print job preempted the large print job is equal to or greater than a threshold amount of time. If so, then additional preemption of the large print job is not permitted. This helps to avoid the large print job being preempted for large periods of time during each preemption by a smaller print job.

Assuming that the large print job may be preempted based on the above determinations, the large print job is suspended, i.e. processing of the print job and output of the pages corresponding to the print job is discontinued. Processing of the small print job is then initiated with the output of this small print job being redirected to a different output device, e.g., output tray of the network printer 440.

This preemption is depicted in FIG. 4 in that at a first time the print queue 450 shows Job A have a status in which page 20 of Job A is currently printing while Job B waits to be processed. The output of Job A is sent to output tray 1 of the network printer 440. At some time later, it is determined that Job A should be preempted so that Job B may be completed. As a result, Job A has a status of preempted and Job B has a status in which page 1 of the print job is being printed. The output of Job B is redirected to output tray 2 of the network printer 440 so that the output of Job A and Job B are not intermingled.

FIG. 5 is a block diagram of one exemplary embodiment of a printer print queue priority self-monitoring mechanism in accordance with the present invention. The elements shown in FIG. 5 may be implemented in hardware, software, or any combination of hardware and software. In a preferred embodiment of the present invention, the various elements are implemented as software instructions executed on one or more processing devices. In addition, as mentioned previously, the print queue priority self-monitoring mechanism of FIG. 5 may be implemented in a network printer, such as network printer 440, in a printer server, such as server 104, may be distributed across a network printer and a printer server, or may be implemented in another type of computing device without departing from the spirit and scope of the present invention.

As shown in FIG. 5, the print queue priority self-monitoring mechanism includes a controller 510, a network interface 520, a print job classification module 530, a print queue 540, a print queue checking module 550, a timers and preemption values storage 560, a print job preemption module 570, and an output redirection module 580. The elements 510-580 are in communication with one another via the control/data bus 590. Although a bus architecture is shown in FIG. 5, the present invention is not limited to such and any architecture that permits the communication of control and data signals between the elements 510-580 may be used without departing from the spirit and scope of the present invention.

The controller 510 controls the overall operation of the print queue priority self-monitoring mechanism and orchestrates the operation of the other elements 520-580. The controller 510 may receive print job requests via the network interface 520, tag them with a timestamp associated with when the print job request was received, and provide them to the print job classification module 530. The print job classification module 530 classifies the print job based on classifications defined by threshold values stored in the timers and preemption values storage 560. The print job classification module 530 may then tag the print job with a tag identifying the classification of the print job, e.g., large, medium or small. The print job is then queued in the print queue 540.

Periodically, according to a print queue check period defined in the timers and preemption values storage 560, the print queue checking module 550 checks the print queue 540 to determine if there are any large print jobs currently being processed by the printer with small print jobs waiting for completion of the large print job. If there is a large print job, i.e. a print job that may be preempted, being processed with a small print job, i.e. a print job that may preempt another print job, waiting to be processed, then the print queue checking module 550 checks the oldest of the small print jobs to determine if the oldest small print job has been waiting in the queue for a predetermined period of time, i.e. a minimum wait time. This may be done, for example, by comparing the timestamp associated with the receipt of the oldest small print job with the current time. If the difference between these times is equal to or greater than the minimum wait time, then the oldest small print job has waited the requisite minimum amount of time in the print queue 540.

The print queue checking module 550 may then inform the controller 510 that the print job that is currently being processed may need to be preempted. In turn, the controller 510 instructs the print job preemption module to operate on the large and small print jobs currently pending in the print queue 540. The print job preemption module 560 retrieves the cumulative preemption time value and current preemption time values from the timers and preemption values storage 560. The print job preemption module 570 then determines whether the cumulative preemption time for previous preemptions by small print jobs is equal to or greater than a predetermined threshold (which may also be stored in the timers and preemption values storage 560). If the cumulative preemption time is equal to or greater than the predetermined threshold, then preemption is not permitted and the large print job continues to be processed while the small print job must continue to wait in the print queue. A response is sent from the print job preemption module 570 to the controller 510 indicating that preemption is not permitted and the operation terminates until the next print queue check.

If the cumulative preemption time is not equal to or greater than the predetermined threshold, then a determination is made as to whether the current preemption time value is equal to or greater than a predetermined threshold. This current preemption time value is generated when a small print job preempts a large print job and is a measure of how long that particular preemption occurs. This value may be reinitialized when a predetermined period of time has elapsed since a last preemption of the large print job.

If the current preemption time is equal to or greater than the predetermined threshold, then further preemption is not permitted. A response may be sent to the controller 510 that indicates that preemption is not permitted and the operation may then terminate until the next print queue check.

If, however, the current preemption time is not equal to or greater than the predetermined threshold, then preemption is permitted. As a result, the print job preemption module 570 the large print job is suspended, i.e. processing of the print job and output of the pages corresponding to the print job is discontinued. Processing of the small print job is then initiated. The output redirection module 570 redirects the output of this small print job to a different output device, e.g., output tray, from that used by the large print job.

Once the small print job has completed, the controller 510 instructs the cumulative preemption time value and current preemption time values in the timers and preemption values storage 560 to be updated based on the preemption time for the preemption by the completed small print job. The controller 510 then instructs the print queue checking module 550 to determine whether there are any additional small print jobs waiting in the print queue 540. If so, the print job preemption module 560 again determines whether the updated cumulative and current preemption time values equal or exceed their respective thresholds.

If either of these determinations comes back true, then preemption by the other small print job(s) in the print queue 540 is not permitted. If, however, neither of these determinations comes back true, then preemption by a next oldest small print job in the print queue 540 is permitted and the processing of the next oldest small print job is initiated. The output of this next oldest small print job is directed to the same output device as the previous small print job in order to keep it separate from the preempted large print job. This process may be repeated as long as there are small print jobs pending in the print queue 540 and the cumulative and current preemption time values do not equal or exceed their respective thresholds.

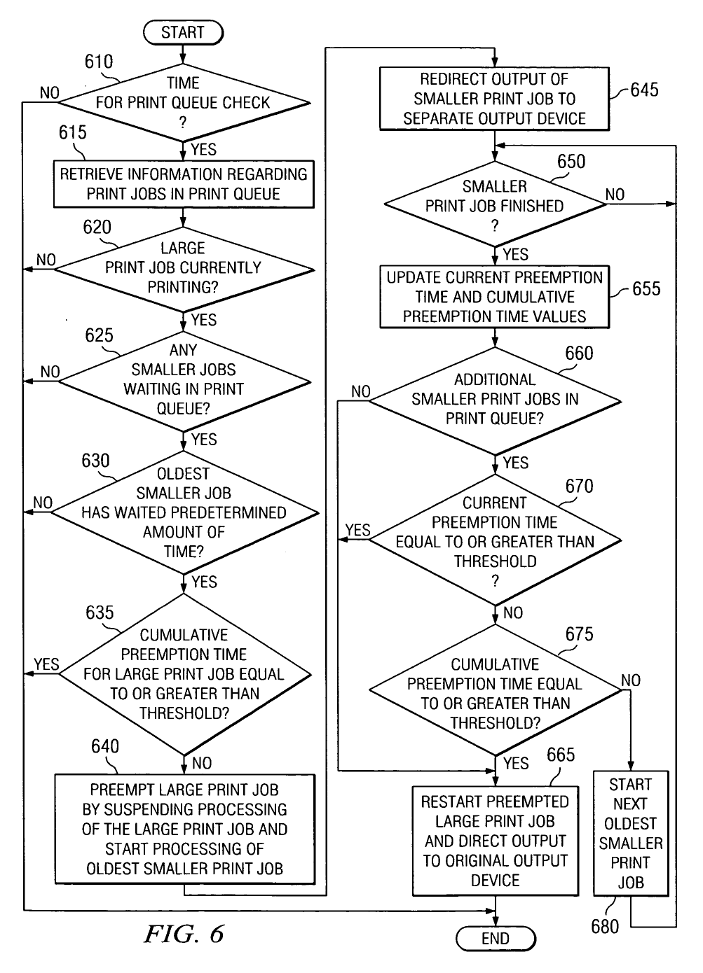

FIG. 6 is a flowchart outlining an exemplary operation of the present invention when performing print queue priority self-monitoring. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 6, the operation starts with a determination as to whether it is time to check the print queue (step 610). If not, the operation terminates. If it is time to check the print queue, information about the print jobs currently present in the print queue is obtained (step 615). A determination is made as to whether there are any large print jobs currently being processed in the print queue (step 620). If not, the operation terminates. If there is a large print job being processed, a determination is made as to whether there are any smaller jobs waiting in the print queue (step 625). If not, the operation terminates.

If there is a large print job being processed and there are smaller print jobs waiting in the print queue, a determination is made as to whether the oldest smaller print job has waited a predetermined period of time in the print queue (step 630). If not, the operation terminates. If the oldest smaller print job has waited the required amount of time, a determination is made as to whether the cumulative preemption time for the large print job is equal to or greater than a predetermined threshold (step 635). If so, the operation terminates.

If the cumulative preemption time for the large print job is not equal to or greater than the predetermined threshold, then the large print job is suspended and processing of the oldest smaller print job is initiated (step 640). The output of the smaller print job is redirected to a separate output device (step 645).

A determination is then made as to whether the smaller print job has finished processing (step 650). If not, the operation loops back to step 650 until the smaller print job finishes processing. Once the smaller print job finishes processing, the current preemption time and cumulative preemption time values are updated (step 655). A determination is then made as to whether there are any additional smaller print jobs waiting in the print queue (step 660). If not, the large print job is restarted and the output is directed to the original output device (step 665). The operation then terminates.

If there are additional smaller print jobs in the print queue (step 660), a determination is made as to whether the current preemption time is equal to or greater than a predetermined threshold (step 670). If not, a determination is made as to whether the cumulative preemption time is equal to or greater than a predetermined threshold (step 675). If not, the next oldest smaller print job is started (step 680) and the operation returns to step 650. If either of the determinations in steps 670 and 675 are true, then the large print job is restarted and the output is redirected to the original output device (step 665) with the operation terminating thereafter.

Thus, the present invention provides an automated mechanism for providing printer-side print queue priority self-monitoring. The present invention permits large print jobs, or print jobs classified into a preemptable classification, to be preempted by other print jobs. This reduces the amount of time that smaller print jobs must wait for larger print jobs to finish while minimizing the number of preemptions of large print jobs. In this way, productivity of users is increased by reducing the amount of time users are idle waiting for print jobs to complete and resources are conserved by reducing the need to send a print job to a plurality of different printers in order to obtain the output of the print job quicker.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for managing print jobs directed to a printer, comprising:
identifying a first print job being processed by the printer, wherein the first print job is a preemptable print job and output generated by processing the first print job is directed to a first output device of the printer;
identifying a second print job, waiting in a print queue associated with the printer, that may initiate preemption of the first print job;
automatically suspending processing of the first print job;
automatically initiating processing of the second print job; and
automatically redirecting output generated by processing the second print job to a second output device of the printer which is different than the first output device.

2. The method of claim 1, further comprising:
determining if a print queue wait time associated with the second print job is equal to or greater than a predetermined threshold period of time, wherein automatically suspending processing of the first print job, automatically initiating processing of the second print job, and automatically redirecting output generated by processing the second print job are performed only if the print queue wait time is greater than the predetermined threshold period of time.

3. The method of claim 1, further comprising:
determining if a cumulative period of time that the first print job has been suspended by other print jobs is equal to or greater than a predetermined threshold period of time, wherein automatically suspending processing of the first print job, automatically initiating processing of the second print job, and automatically redirecting output generated by processing the second print job are performed only if the cumulative period of time is greater than the predetermined threshold period of time.

4. The method of claim 1, further comprising:
upon completion of the second print job, determining a total time that the first print job was suspended due to preemption by the second print job; and
updating a cumulative period of time that the first print job has been suspended based on the total time that the first print job was suspended due to preemption by the second print job.

5. The method of claim 1, further comprising:
upon completion of the second print job, determining if there are any additional print jobs in the print queue that may preempt the first print job; and
if there are no additional print jobs in the print queue that may preempt the first print job, automatically restarting processing of the first print job and redirecting output generated by processing the first print job to the first output device of the printer.

6. The method of claim 5, further comprising:
determining if a total time that the first print job was preempted by the second print job is equal to or greater than a predetermined threshold; and
automatically restarting processing of the first print job and redirecting output generated based on processing the first print job to the first output device of the printer, if the total time that the first print job was preempted by the second print job is equal to or greater than the predetermined threshold.

7. The method of claim 5, further comprising:
determining if a cumulative time that the first print job has been preempted by other print jobs is equal to or greater than a predetermined threshold; and
automatically restarting processing of the first print job and redirecting output generated based on processing the first print job to the first output device of the printer, if the cumulative time that the first print job has been preempted by other print jobs is equal to or greater than the predetermined threshold.

8. A computer program product in a computer readable medium for managing print jobs directed to a printer, comprising:
first instructions for identifying a first print job being processed by the printer, wherein the first print job is a preemptable print job and output generated by processing the first print job is directed to a first output device of the printer;
second instructions for identifying a second print job, waiting in a print queue associated with the printer, that may initiate preemption of the first print job;
third instructions for automatically suspending processing of the first print job;
fourth instructions for automatically initiating processing of the second print job; and
fifth instructions for automatically redirecting output generated by processing the second print job to a second output device of the printer which is different than the first output device.

9. The computer program product of claim 8, further comprising:
sixth instructions for determining if a print queue wait time associated with the second print job is equal to or greater than a predetermined threshold period of time, wherein the third, fourth and fifth instructions are executed only if the print queue wait time is greater than the predetermined threshold period of time.

10. The computer program product of claim 8, further comprising:
sixth instructions for determining if a cumulative period of time that the first print job has been suspended by other print jobs is equal to or greater than a predetermined threshold period of time, wherein the third, fourth and fifth instructions are executed only if the cumulative period of time is greater than the predetermined threshold period of time.

11. The computer program product of claim 8, further comprising:
sixth instructions for determining a total time that the first print job was suspended due to preemption by the second print job, upon completion of the second print job; and
seventh instructions for updating a cumulative period of time that the first print job has been suspended based on the total time that the first print job was suspended due to preemption by the second print job.

12. The computer program product of claim 8, further comprising:
sixth instructions for determining if there are any additional print jobs in the print queue that may preempt the first print job, upon completion of the second print job; and
seventh instructions for automatically restarting processing of the first print job and redirecting output generated by processing the first print job to the first output device of the printer, if there are no additional print jobs in the print queue that may preempt the first print job.

13. The computer program product of claim 12, further comprising:
eighth instructions for determining if a total time that the first print job was preempted by the second print job is equal to or greater than a predetermined threshold; and
ninth instructions for automatically restarting processing of the first print job and redirecting output generated based on processing the first print job to the first output device of the printer, if the total time that the first print job was preempted by the second print job is equal to or greater than the predetermined threshold.

14. The computer program product of claim 12, further comprising:
eighth instructions for determining if a cumulative time that the first print job has been preempted by other print jobs is equal to or greater than a predetermined threshold; and
ninth instructions for automatically restarting processing of the first print job and redirecting output generated based on processing the first print job to the first output device of the printer, if the cumulative time that the first print job has been preempted by other print jobs is equal to or greater than the predetermined threshold.

15. An apparatus for managing print jobs directed to a printer, comprising:
means for identifying a first print job being processed by the printer, wherein the first print job is a preemptable print job and output generated by processing the first print job is directed to a first output device of the printer;
means for identifying a second print job, waiting in a print queue associated with the printer, that may initiate preemption of the first print job;
means for automatically suspending processing of the first print job;
means for automatically initiating processing of the second print job; and
means for automatically redirecting output generated by processing the second print job to a second output device of the printer which is different than the first output device.

16. The apparatus of claim 15, further comprising:
means for determining if a print queue wait time associated with the second print job is equal to or greater than a predetermined threshold period of time, wherein the means for automatically suspending, means for automatically initiating, and means for automatically redirecting operate only if the print queue wait time is greater than the predetermined threshold period of time.

17. The apparatus of claim 15, further comprising:
means for determining if a cumulative period of time that the first print job has been suspended by other print jobs is equal to or greater than a predetermined threshold period of time, wherein the means for automatically suspending, means for automatically initiating, and means for automatically redirecting operate only if the cumulative period of time is greater than the predetermined threshold period of time.

18. The apparatus of claim 15, further comprising:
means for determining a total time that the first print job was suspended due to preemption by the second print job, upon completion of the second print job; and
means for updating a cumulative period of time that the first print job has been suspended based on the total time that the first print job was suspended due to preemption by the second print job.

19. The apparatus of claim 15, further comprising:
means for determining if there are any additional print jobs in the print queue that may preempt the first print job, upon completion of the second print job; and
means for automatically restarting processing of the first print job and redirecting output generated by processing the first print job to the first output device of the printer, if there are no additional print jobs in the print queue that may preempt the first print job.

20. The apparatus of claim 19, further comprising:
means for determining if a total time that the first print job was preempted by the second print job is equal to or greater than a predetermined threshold; and
means for automatically restarting processing of the first print job and redirecting output generated based on processing the first print job to the first output device of the printer, if the total time that the first print job was preempted by the second print job is equal to or greater than the predetermined threshold.

21. The apparatus of claim 19, further comprising:
means for determining if a cumulative time that the first print job has been preempted by other print jobs is equal to or greater than a predetermined threshold; and
means for automatically restarting processing of the first print job and redirecting output generated based on processing the first print job to the first output device of the printer, if the cumulative time that the first print job has been preempted by other print jobs is equal to or greater than the predetermined threshold.
